(19) United States
(12) Patent Application Publication
(10) Pub. No.: US 2023/0113779 A1
(43) Pub. Date: Apr. 13, 2023

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Masaaki Sato, Kanagawa (JP)

(21) Appl. No.: 17/955,118

(22) Filed: Sep. 28, 2022

(30) Foreign Application Priority Data
Oct. 8, 2021 (JP) 2021-166478

(51) Int. Cl. G06F 3/04886; G06F 3/0482

(52) U.S. Cl. CPC G06F 3/04886; G06F 3/0482

(57) ABSTRACT

According to an aspect of the present invention, an information processing apparatus comprises a memory and at least one processor in communication with the memory, wherein the at least one processor is configured to perform accepting an operation on an input field included in a web content obtained via a network and controlling whether or not a first on-screen keyboard used on the information processing apparatus is displayed if the operation is accepted.

### BACKGROUND OF THE INVENTION

### Field of the Invention

The present invention relates to an information processing apparatus, a method for controlling the information processing apparatus, and a storage medium storing a program for providing a function for launching an input keyboard associated with displayed content.

### Description of the Related Art

Some MFPs (Multi Function Peripheral, hereinafter referred to as “image forming apparatus”) typically include web browsers as well as scanners and printers. Users touch to enter characters in an input field (for example, a login ID or password for authentication) displayed in the web browser. Upon recognizing touch by the web browser, the web browser provides an input keyboard (hereafter referred to as the “first on-screen keyboard (OSK)”) for all content. The first OSK enhances convenience by providing the first OSK when a touch operation is performed in an input field of multiple functions (for example, copy function, send function, and the like) available in the image forming apparatus.

In recent years, there have also been keyboards (hereafter referred to as the “second OSK”) that support input fields for web content displayed in the web browsers. In the web browser, it is common to provide a keyboard including only characters that can be entered in the input field, or to provide a per-language keyboard to support input in a plurality of languages. It is also common to provide a plurality of pre-prepared keyboard choices for the user to enter in the input field (Japanese Patent Application Laid-Open No. 2002-251250).

By the way, if a user touches an input field in a web browser in a case where the input field supports a second OSK, the web browser sometimes displays a first OSK. In this case, the user could not input in the second OSK, which increased the number of operations in the first OSK, a web browser becomes less convenient.

### SUMMARY OF THE INVENTION

In view of the above issues, it is an object of the present invention to provide a web browser that enables keyboard input in either a first OSK or a second OSK based on a setting.

According to an aspect of the present invention, an information processing apparatus comprises: a memory and at least one processor in communication with the memory, wherein the at least one processor is configured to perform accepting operation on an input field included in a web content obtained via a network and controlling whether or not a first on-screen keyboard used on the information processing apparatus is displayed if the operation is accepted.

Further features of the present invention will become apparent from the following description of exemplary embodiments with reference to the attached drawings.

### BRIEF DESCRIPTION OF THE DRAWINGS

FIG. 1 illustrates an overall view of an image processing system in an embodiment of the present invention.

FIG. 2 illustrates a hardware configuration diagram of image forming apparatus according to an embodiment of the present invention.

FIG. 3 illustrates a software configuration diagram of image forming apparatus according to the embodiment of the present invention.

FIG. 4 illustrates a flowchart of the second OSK registration process.

FIG. 5 illustrates a flowchart of second OSK launch process.

FIG. 6A illustrates an image of the content management table.

FIG. 6B illustrates an image of first OSK management table.

FIG. 6C illustrates an image of the management table to be launched.

FIG. 6D illustrates an image of the launch candidate management table.

FIG. 7A illustrates an application example of incoming Web content.

FIG. 7B illustrates an application example of incoming Web content.

FIG. 7C illustrates an application example of incoming Web content.

FIG. 8 illustrates an image of the second OSK to be displayed.

FIG. 9A illustrates an illustration of Web content to be displayed.

FIG. 9B illustrates an image of the first OSK.

FIG. 10 illustrates an image of the keyboard candidate list screen to be displayed.

FIG. 11 illustrates a flowchart of second OSK registration process.

FIG. 12 illustrates a flowchart of second OSK registration process.

FIG. 13 illustrates a flowchart of second OSK registration process.

FIG. 14 illustrates a flowchart of second OSK launch process.

### DESCRIPTION OF THE EMBODIMENTS

Hereafter, the configuration for carrying out the present invention is described using drawings. It should be noted that the following embodiment does not limit the invention claimed, and not all combinations of features described in the embodiment are essential to the means of solving the invention.

An image forming apparatus according to an example of the present invention will be described.

### First Embodiment

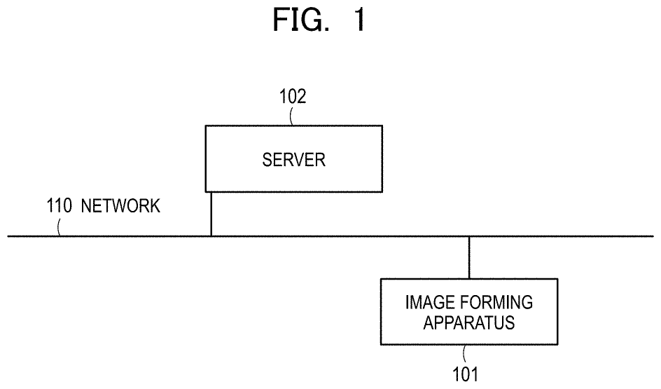

FIG. 1 illustrates an overall view of the image processing system in the first embodiment. In a network 110, an image forming apparatus 101, which is an information processing apparatus, and a server 102 are connected to communicate with each other.

(Hardware Configuration of the Image Forming Apparatus)

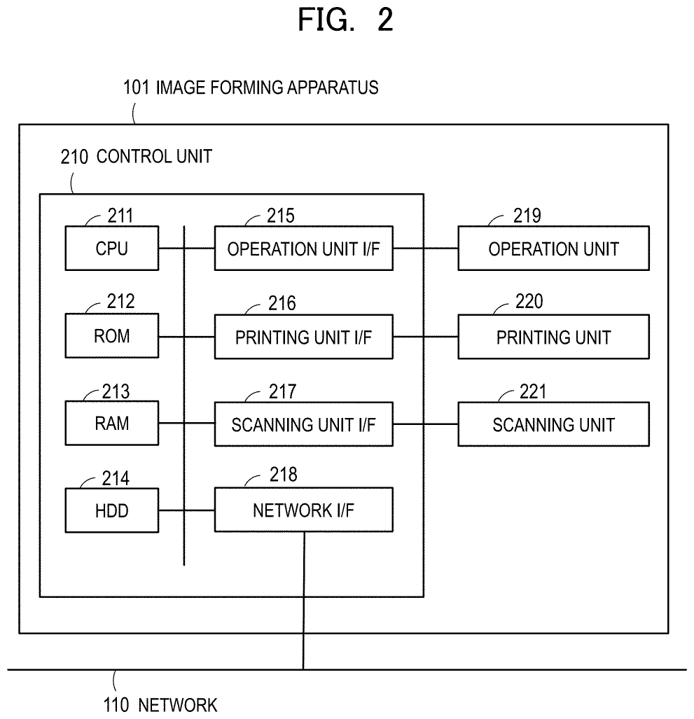

FIG. 2 illustrates a block diagram showing the hardware configuration of the image forming apparatus 101, which is an information processing apparatus. A control unit 210 including a CPU 211 controls the operation of the entire image forming apparatus 101. The CPU 211 reads a control program stored in a ROM 212 and executes various control processing such as read control and transmission control. A RAM 213 is used as a transitory storage area such as a main memory and a work area of the CPU 211. A HDD 214 stores image data and various programs. An operation unit I/F 215 connects an operation unit 219 and the control unit 210. The operation unit 219 is equipped with a liquid crystal display unit with a touch panel function, a keyboard, and the like.

A printing unit I/F 216 connects a printing unit 220 to the control unit 210. The image data to be printed by the printing unit 220 is transferred from the control unit 210 to the printing unit 220 via the printing unit I/F 216, and printed on a recording medium by the printing unit 220. A scanning unit I/F 217 connects a scanning unit 221 to the control unit 210. The scanning unit 221 scans an image on a document to generate image data, which is input to the control unit 210 via the scanning unit I/F 217.

A network I/F 218 connects the control unit 210 to the network 110. When the URL address of the connection-destination server 102 to be accessed is specified in the web browser displayed on the LCD by the user, the network I/F 218 transmits a request to an external apparatus (e.g., the server 102) on the network 110. Upon receiving the request, the server 102 returns a response of the corresponding web content to the web browser. Responses of the web content are generally described using HTML, CSS, JavaScript, and the like. The web browser installed in the image forming apparatus 101 converts the web content acquired from the server 102 into an input field or the like (generally referred to as browser rendering processing or the like). The web browser displays the rendered result on the LCD.

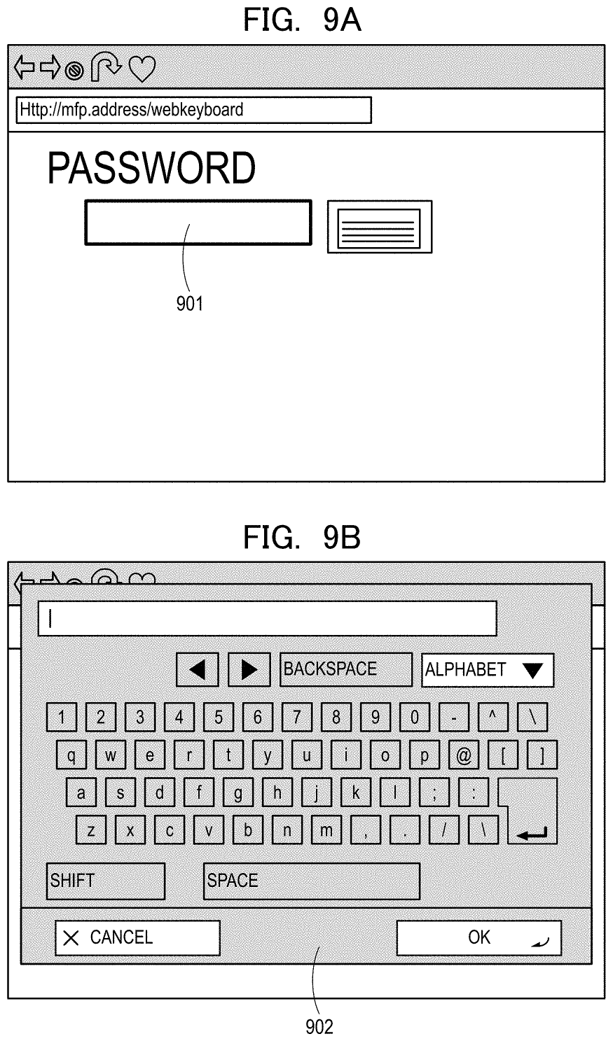

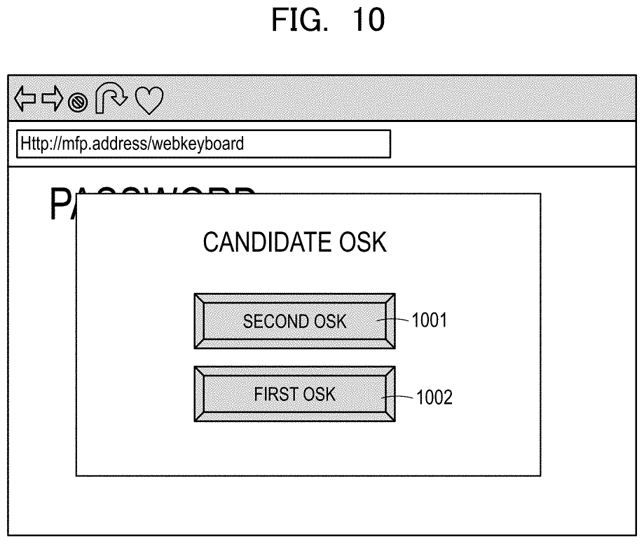

FIG. 9A illustrates an image diagram of the web content displayed by the web browser. The user specifies a password by touching a password input field 901. FIG. 9B illustrates an image diagram of a first OSK 902 that supports all the web content provided by the web browser by touch operation.

(Software Configuration of the Image Forming Apparatus)

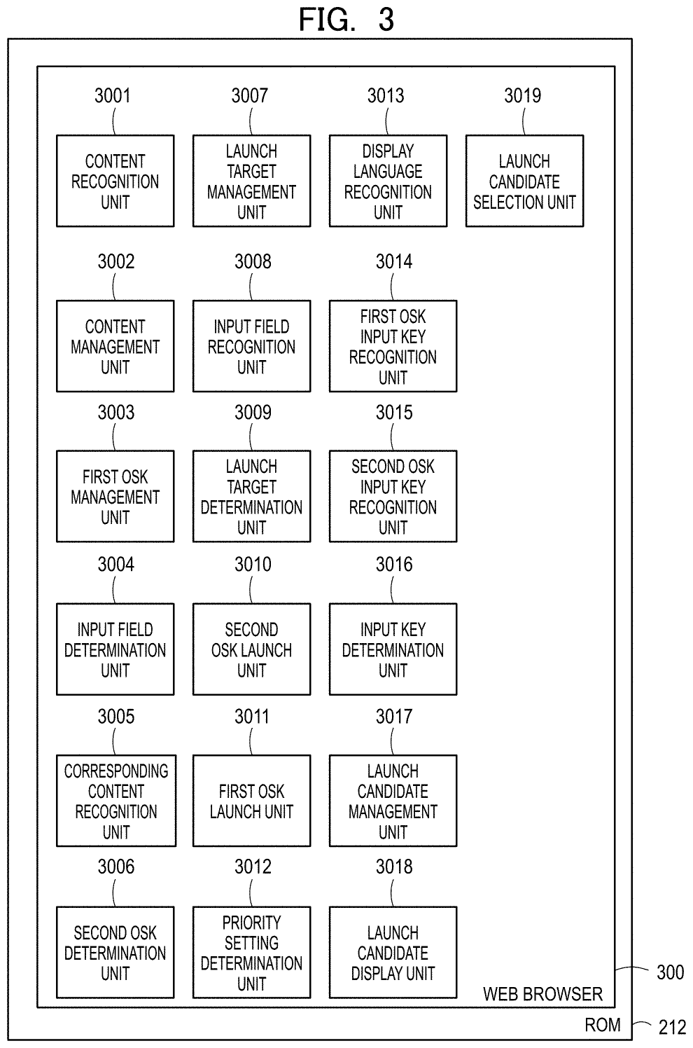

FIG. 3 illustrates a software configuration diagram of each control program stored in the ROM 212 of the image forming apparatus 101, which is an information processing apparatus, and each control of the image forming apparatus 101 is realized by the CPU 211 executing each of these control programs. A web browser 300 includes a content recognition unit 3001, a content management unit 3002, a first OSK management unit 3003, an input field determination unit 3004, and a corresponding content recognition unit 3005. Furthermore, the web browser 300 also includes a second OSK determination unit 3006, a launch target management unit 3007, an input field recognition unit 3008, a launch target determination unit 3009, a second OSK launch unit 3010, and a first OSK launch unit 3011.

The content recognition unit 3001 receives a response of the web content from the server 102, recognizes the acquired web content, and returns a plurality of content elements included in the acquired web content.

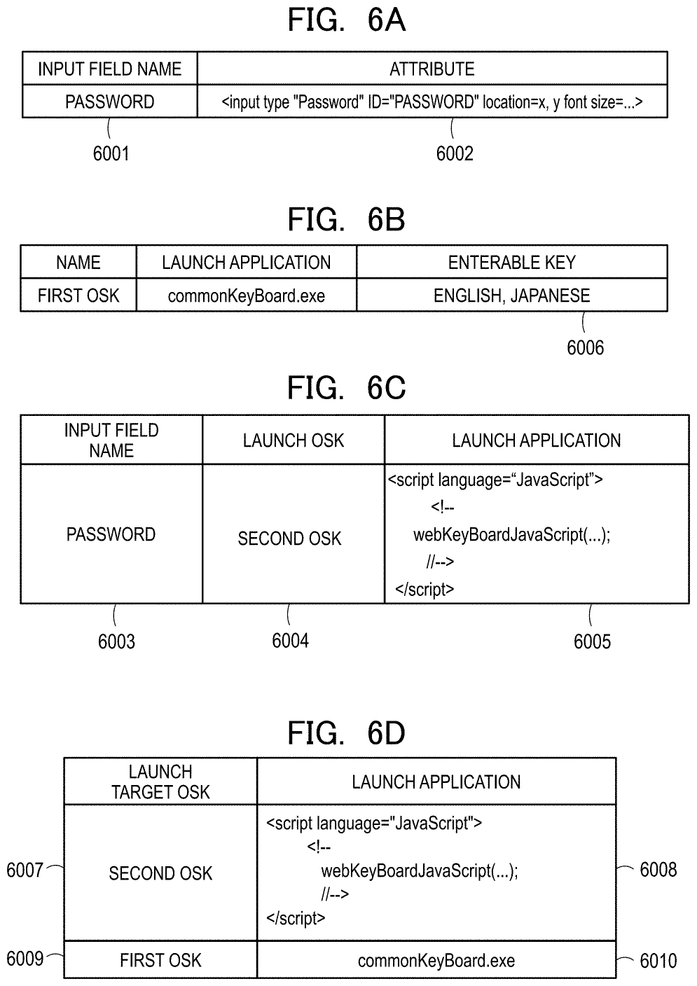

The content management unit 3002 registers web content for each content element and provides the registered content. FIG. 6A illustrates an image diagram of the content management table. Specifically, the content management table manages an input field name 6001 and an attribute 6002. The attribute is a value used by the web browser 300 to render the web content. Specifically, the position and character size of the input field are specified.

The first OSK management unit 3003 manages the first OSK provided to input a character string corresponding to the input field. FIG. 6B illustrates an image of the first OSK management table. Specifically, a name of OSK, launch applications, and enterable keys 6006 corresponding to the input field are managed.

The input field determination unit 3004 determines whether or not the content element is the input field.

The corresponding content recognition unit 3005 recognizes web content, which is information corresponding to the input field, and returns the recognized result. For example, if the web content that is information corresponding to the input field includes the second OSK, it is returned.

The second OSK determination unit 3006 determines whether or not the web content includes a second OSK.

The launch target management unit 3007 manages a keyboard to be launched for each input field. FIG. 6C illustrates an image of the launch target management table. Specifically, an input field name 6003, a launch OSK 6004, and a launch application 6005 are managed.

The input field recognition unit 3008 recognizes a name of a specific input field when the specific input field is touched. The launch target determination unit 3009 determines whether or not the keyboard to be launched corresponding to the input field is the second OSK. The second OSK launch unit 3010 launches the second OSK and displays the specific second OSK on the liquid crystal display unit. This allows the user to enter characters in the second OSK.

The first OSK launch unit 3011 launches the first OSK and displays the first OSK on the liquid crystal display. This allows the user to enter characters in the first OSK. The first OSK is an on-screen keyboard commonly used in different applications executed in the image forming apparatus 101 and is the on-screen keyboard included in the image forming apparatus 101.

(Registration Processing of the Second OSK)

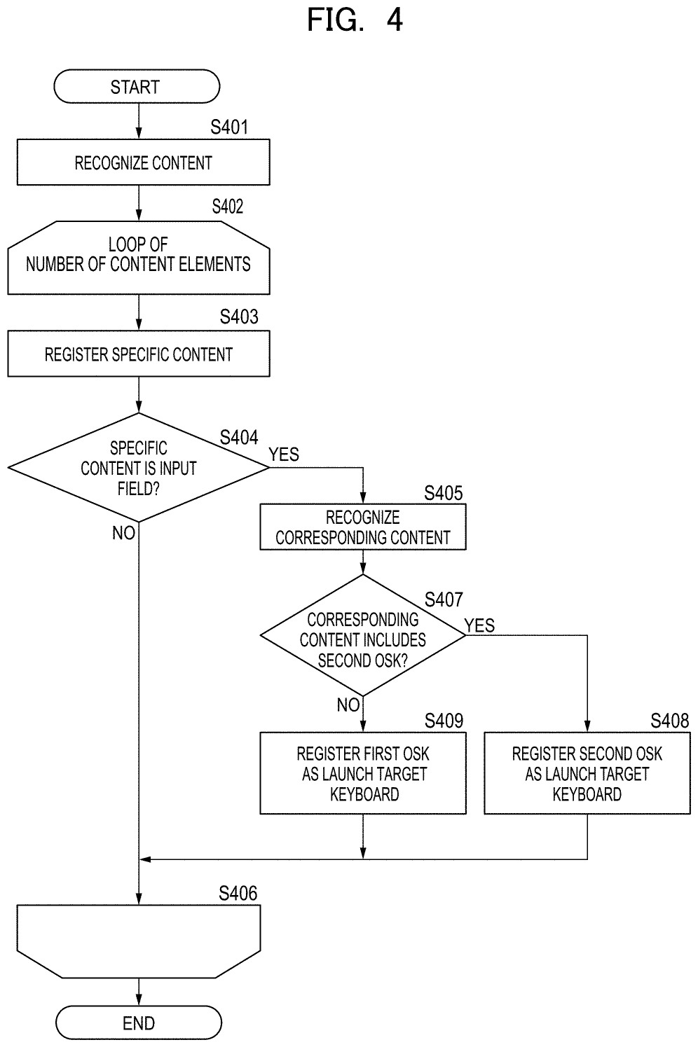

FIG. 4 illustrates a flowchart showing the second OSK registration process, in which the web browser 300 of the image forming apparatus 101 in the present embodiment receives a response of the web content from the server 102, recognizes and executes the acquired web content. Each step shown in the flowchart of FIG. 4 is executed by the CPU 211 of the image forming apparatus 101 deploying the control program stored in a memory such as the ROM 212 to the RAM 213 and executing the control program.

In step S401, the CPU 211 recognizes that the web browser 300 has received a response of web content from the server 102 using the content recognition unit 3001. From step S402 to step S406, the CPU 211 repeats the process of reading the plurality of content elements included in the web content using the content recognition unit 3001 by looping for the number of elements. This process is terminated when the loop is terminated.

In step S403, the CPU 211 registers a specific content element in the content management unit 3002. In step S404, the CPU 211 passes the specific content element to the input field determination unit 3004 to determine whether or not the specific content element is the input field. If the specific content element is the input field (Yes in step S404), the process proceeds to step S405. Otherwise (No in step S404), the process proceeds to step S406 and proceeds to the next element.

In step S405, the CPU 211 passes the specific content element to the corresponding content recognition unit 3005 to recognize the web content corresponding to the input field.

In step S407, the CPU 211 passes the corresponding web content recognized in step S405 to the second OSK determination unit 3006 to determine whether or not there is a second OSK. If the second OSK is present (Yes in step S407), the process proceeds to step S408, and if not (No in step S407), the process proceeds to step S409.

In step S408, the CPU 211 registers the second OSK recognized by the corresponding content recognition unit 3005 as a launch target in the launch target management unit 3007 for a specific content element, and then proceeds to step S406 and proceeds to the next element.

In step S409, the CPU 211 registers the first OSK managed by the first OSK management unit 3003 as a launch target in the launch target management unit 3007 for a specific content element, and then proceeds to step S406 and proceeds to the next element.

(Launch Processing of the Second OSK)

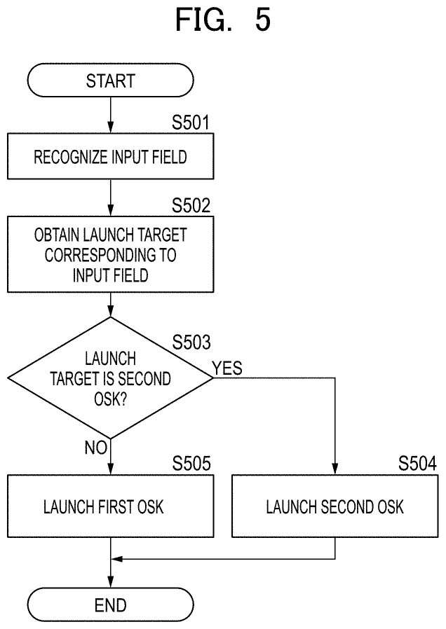

FIG. 5 illustrates a flowchart showing the second OSK launch processing, in which the user touches an input field in the web browser 300 of the image forming apparatus 101 in the present embodiment, and the CPU 211 recognizes the touch of the input field of the web browser 300 and executes launching the second OSK. Each step shown in the flowchart of FIG. 5 is executed by the CPU 211 of the image forming apparatus 101 deploying the control program stored in a memory such as the ROM 212 to the RAM 213 and executing the control program.

In step S501, the CPU 211 recognizes the specific input field touched using the input field recognition unit 3008. In step S502, the CPU 211 acquires a keyboard to be launched that matches the input field specified in step S501 from the content element managed by the launch target management unit 3007.

In step S503, the CPU 211 passes the keyboard acquired in step S502 to the launch target determination unit 3009 to determine whether or not the keyboard to be launched is the second OSK. In the case of the second OSK (Yes in step S503), the process proceeds to step S504, otherwise (No in step S503), the process proceeds to step S505.

In step S504, the CPU 211 passes the launch application of the second OSK acquired in step S502 to the second OSK launch unit 3010. The second OSK launch unit 3010 launches the second OSK and controls the display so that the specific second OSK is displayed on the liquid crystal display unit. This allows the user to input characters using the second OSK. The process is then terminated.

In step S505, the CPU 211 passes the launch application of the first OSK acquired in step S502 to the first OSK launch unit 3011. The first OSK launch unit 3011 launches the first OSK and controls the display so that the first OSK is displayed on the liquid crystal display. This allows the user to input characters using the first OSK. The process is then terminated.

(Example of Registration and Launch of the Second OSK)

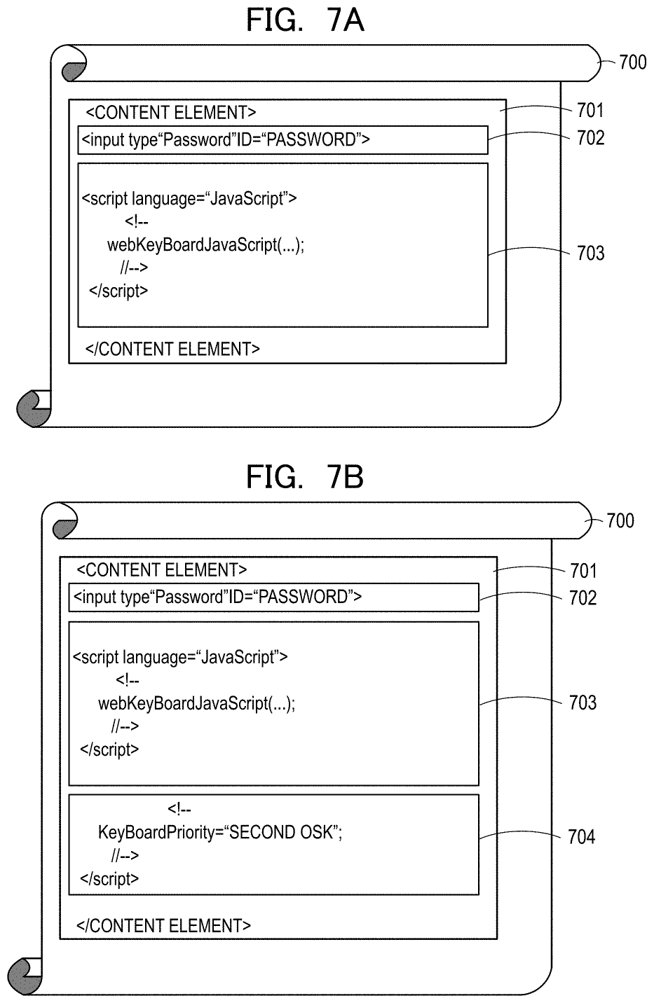

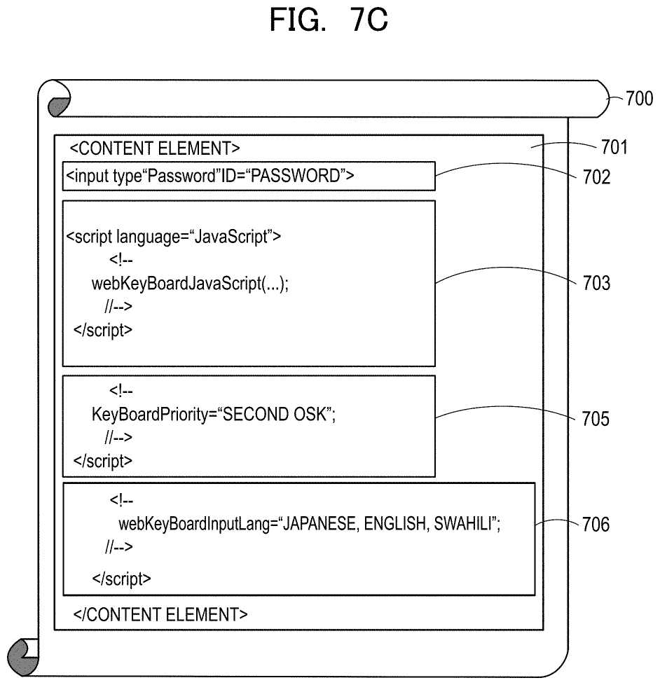

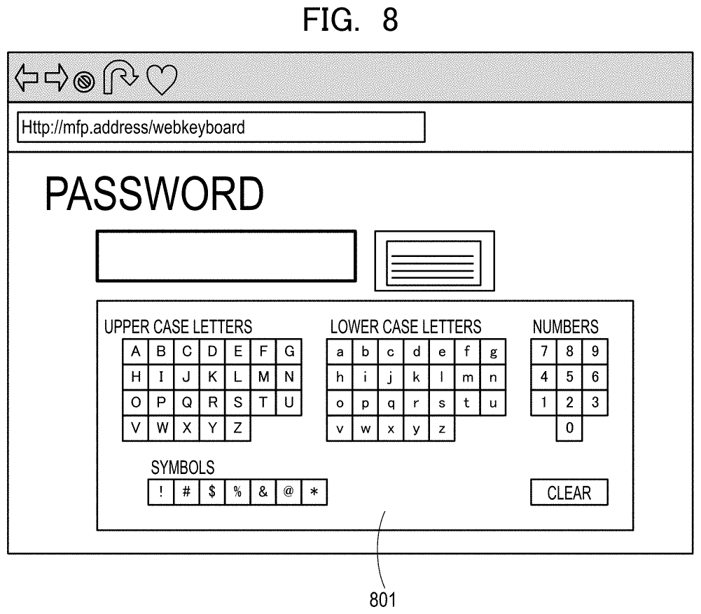

FIGS. 7A and 8 illustrate an operation example in which the second OSK registration process and the second OSK launch process are executed. The web browser 300 receives a response of a web content 700 from the server 102, recognizes the acquired web content 700 (FIG. 7A), and executes the second OSK registration process of FIG. 4.

In step S401, the CPU 211 recognizes that the web browser 300 has received a response of the web content 700 from the server 102 using the content recognition unit 3001.

From step S402 to step S406, the CPU 211 repeats the process of reading the plurality of content elements included in the web content using the content recognition unit 3001 according to the number of elements. The CPU 211 recognizes content elements 701.

In step S403, the CPU 211 registers the content element 701 in the content management unit 3002. The CPU 211 registers “PASSWORD” for the ID in the input field name 6001, and registers the content element 701 in the attribute 6002.

In step S404, the CPU 211 passes the content element 701 to the input field determination unit 3004 to determine whether or not the specific content element 701 is an input field. The input field determination unit 3004 determines that a content element 702 is an input field and the process proceeds to step S405.

In step S405, the CPU 211 passes the specific content element 701 to the corresponding content recognition unit 3005 to recognize a web content 703 corresponding to the input field.

In step S407, the CPU 211 passes the corresponding web content 703 recognized in step S405 to the second OSK determination unit 3006 to determine whether or not the web content 703 includes the second OSK. The second OSK determination unit 3006 determines that the second OSK is included in the web content 703 and the process proceeds to step S408.

In step S408, the CPU 211 registers the web content 703 recognized by the corresponding content recognition unit 3005 with respect to the specific content element 703 in the launch target management unit 3007 as a launch target. The CPU 211 registers the “PASSWORD” for the ID in the input field name 6003, the “2nd OSK” in the launch OSK 6004, and the web content 703 in the launch application 6005.

Then, the web browser 300 displays the specific content element 703 on the liquid crystal display, and the user touches the input field. The second OSK launch processing that recognizes and executes touch of the input field of the web browser 300 is described.

In step S501, the CPU 211 recognizes the specific input field touched using the input field recognition unit 3008. The CPU 211 recognizes the input field name “PASSWORD.”

In step S502, the CPU 211 acquires a keyboard to be launched that matches the input field (“PASSWORD”) specified in step S501 from the content element managed by the launch target management unit 3007. In the present example, the CPU 211 acquires the launch OSK 6004 and the launch application 6005.

In step S503, the CPU 211 passes the launch OSK 6004 acquired in step S502 to the launch target determination unit 3009 to determine whether or not the launch target keyboard is the second OSK. Since the launch target keyboard is the second OSK in the present example, the process proceeds to step S504.

In step S504, the CPU 211 passes the launch application 6005 of the second OSK acquired in step S502 to the second OSK launch unit 3010. The second OSK launch unit 3010 launches the launch application 6005 and controls the second OSK to be displayed on the liquid crystal display unit, which has the effect of enabling character input by the second OSK. FIG. 8 illustrates an image view of a second OSK 801 to be displayed. For example, the second OSK 801 can provide a keyboard that allows the user to enter only necessary characters according to constraints of the input characters, thus usability of an input by a keyboard is enhanced.

### Second Embodiment

An embodiment in which either the second OSK or the first OSK can be preferentially switched based on the setting in case of the second OSK provided from web content will be described. Descriptions of the same parts as those of the first embodiment will be omitted, and focused on differences.

(Software Configuration of the Image Forming Apparatus)

FIG. 3 illustrates a software configuration diagram of each control program stored in the ROM 212 of the image forming apparatus 101, and each control of the image forming apparatus 101 is realized by executing each of these control programs by the CPU 211. The web browser 300 includes a priority setting determination unit 3012 in addition to the control program described in the first embodiment. The priority setting determination unit 3012 determines whether or not the second OSK has priority set to the recognized corresponding content.

(Registration Processing of the Second OSK)

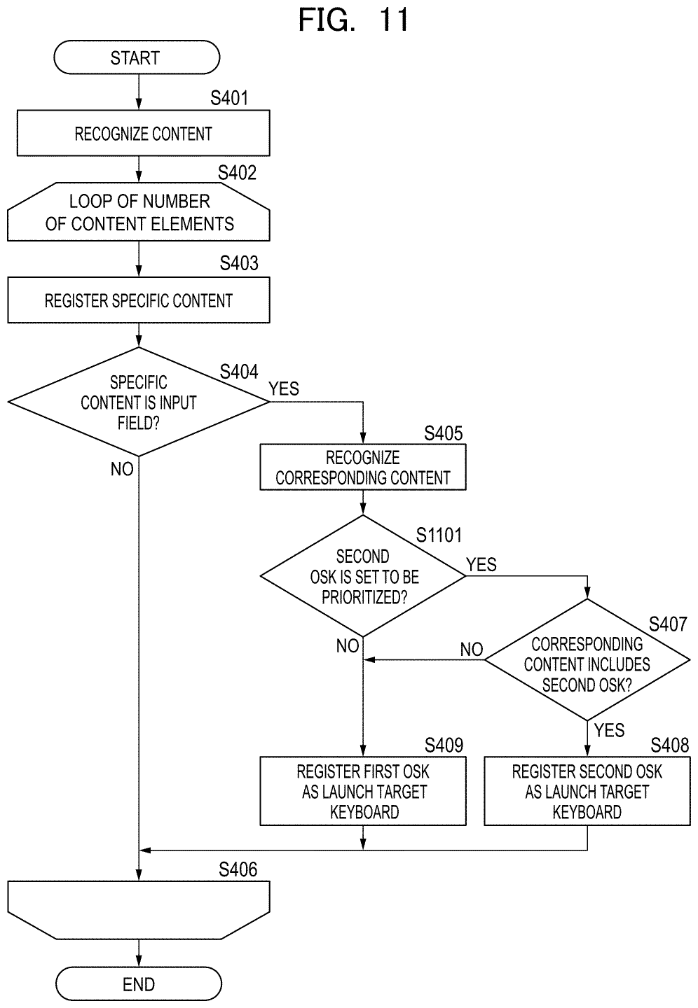

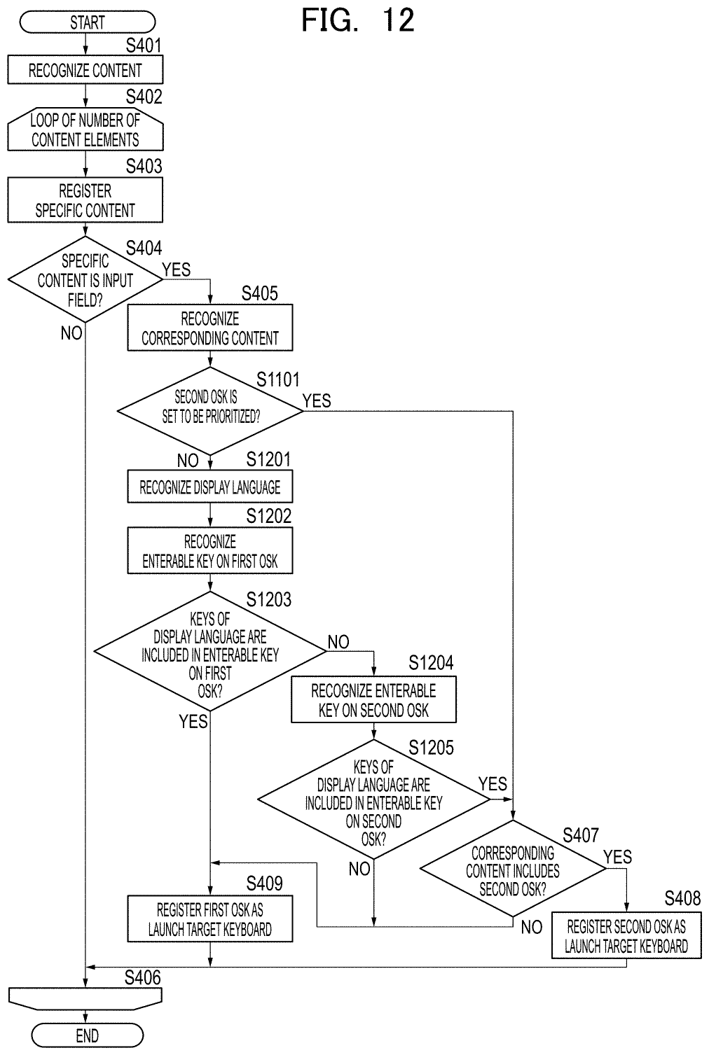

FIG. 11 illustrates a flowchart showing the second OSK registration process, which the web browser 300 of the image forming apparatus 101 in the present embodiment recognizes a response of the web content 700 (FIG. 7B) received from the server 102 and executes the registration process. Each step shown in the flowchart of FIG. 11 is executed by the CPU 211 of the image forming apparatus 101 deploying a control program stored in a memory such as the ROM 212 to the RAM 213 and executing the control program.

In step S1101, the CPU 211 passes a corresponding web content 704 recognized in step S405 to a priority setting determination unit 3012 to determine whether or not the second OSK has priority set to the recognized corresponding web content 704. As a result of the determination, if the second OSK has the priority, the process proceeds to step S407. Otherwise, the process proceeds to step S409.

(Example of Registration of the Second OSK Having Priority Set to Web Content)

An example of applying the second OSK registration process will be described with reference to FIG. 7B. The Web browser 300 receives a response of the web content 700 from the server 102, recognizes the acquired web content 700, and executes the second OSK registration process shown in FIG. 11.

In step S1101, the CPU 211 passes the corresponding content 704 recognized in step S405 to the priority setting determination unit 3012 to determine whether or not the second OSK has priority set to the recognized corresponding web content 704. In this operation, it is determined that the second OSK has priority set to the recognized corresponding web content 704, and the process proceeds to step S407.

For the subsequent processing, the same processing as in the first embodiment is performed. In the present embodiment, by setting a priority setting, it is possible to switch preferentially launching either the second OSK or the first OSK.

### Third Embodiment

The first OSK is set to be used preferentially if the second OSK is provided by the web content. In a specific case, the second OSK is used instead of the first OSK. Specifically, as a specific case, the second OSK has more enterable characters than the first OSK. Hereafter, the differences from the first and second embodiments will be mainly described.

(Software Configuration of the Image Forming Apparatus)

FIG. 3 illustrates the software configuration diagram of each control program stored in the ROM 212 of the image forming apparatus 101, and each control of the image forming apparatus 101 is realized by executing each of these control programs by the CPU 211. In addition to the control program described in the first embodiment, the web browser 300 includes a display language recognition unit 3013, a first OSK input key recognition unit 3014, a second OSK input key recognition unit 3015, and an input key determination unit 3016.

The display language recognition unit 3013 recognizes a specific display language displayed by the web browser 300. The first OSK input key recognition unit 3014 recognizes enterable keys of the first OSK. The second OSK input key recognition unit 3015 recognizes enterable keys of the second OSK for the content.

The input key determination unit 3016 determines whether or not the keys of the recognized display language are included in the enterable keys recognized by the first OSK input key recognition unit 3014 or the second OSK input key recognition unit 3015.

(Registration Processing of the Second OSK)

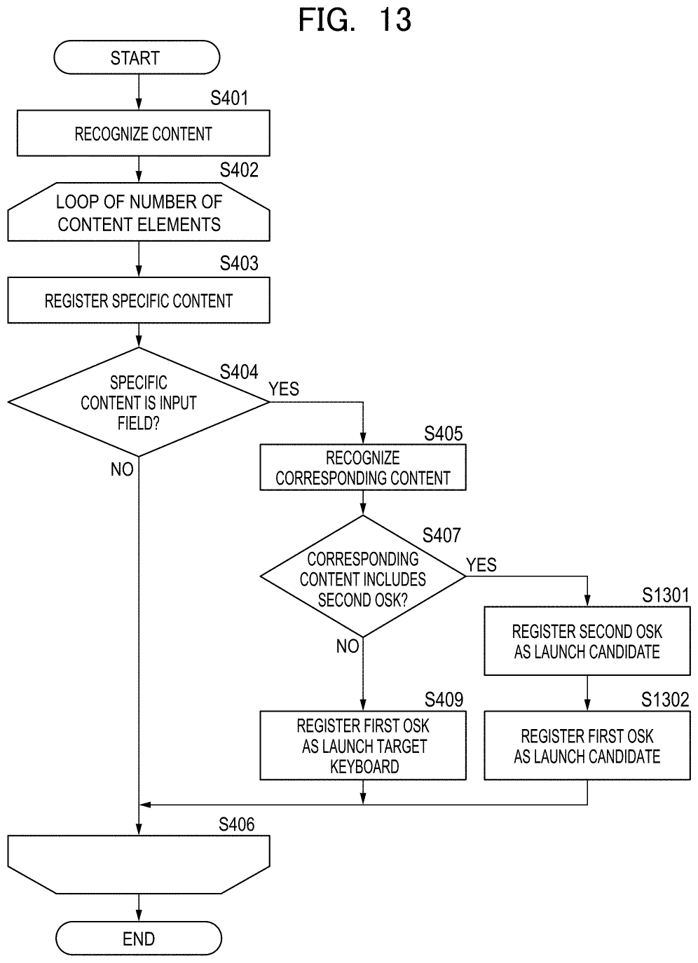

FIG. 12 illustrates a flowchart showing the second OSK registration process, in which the web browser 300 of the image forming apparatus 101 in the present embodiment receives a response of the web content from the server 102, recognizes and executes the acquired web content. Each step shown in the flowchart of FIG. 12 is executed by the CPU 211 of the image forming apparatus 101 deploying a control program stored in a memory such as the ROM 212 to the RAM 213 and executing the control program. First, it is determined in step S1101 that the first OSK has priority and the process proceeds to step S1201.

In step S1201, the CPU 211 recognizes a specific display language displayed by the web browser 300 using the display language recognition unit 3013. In step S1202, the CPU 211 recognizes the enterable keys managed by the first OSK management unit 3003 using the first OSK input key recognition unit 3014.

In step S1203, the CPU 211 passes the display language recognized in step S1201 and the enterable keys by the first OSK recognized in step S1202 to the input key determination unit 3016. The input key determination unit 3016 determines whether or not the keys of the display language are included in the enterable keys by the first OSK. If all the keys of the display language are included in the enterable keys by the first OSK (Yes in step S1203), the process proceeds to step S409. On the other hand, if the keys of the display language are not included in the enterable keys by the first OSK (No in step S1203), the process proceeds to step S1204.

In step S1204, the CPU 211 uses the second OSK input key recognition unit 3015 to recognize the enterable keys by the second OSK of the corresponding content recognized in step S405.

In step S1205, the CPU 211 passes the display language recognized in step S1201 and the enterable keys recognized in step S1204 to the input key determination unit 3016. The input key determination unit 3016 determines whether or not the display language is included in the enterable keys. If there are enterable keys (Yes in step S1205), the process proceeds to step S407. On the other hand, if not (No in step S1205), the process proceeds to step S409.

(Example of the First OSK Including English and Japanese Keys and the Display Language of the Web Browser Including Swahili)

An example of applying the second OSK registration process is described with reference to FIGS. 6B and 7C.

The enterable key 6006 of the first OSK management unit 3003 stores “English” and “Japanese”, and the specific display language displayed by the web browser 300 is “Swahili”. The web browser 300 receives a response of the web content 700 from the server 102, recognizes the acquired web content 700, and executes the second OSK registration process in FIG. 12.

In step S1101, the CPU 211 passes a corresponding content 705 recognized in step S405 to the priority setting determination unit 3012 to determine whether or not the second OSK has priority. In this operation example, it is determined that the first OSK has priority, and the process proceeds to step S1201.

In step S1201, the CPU 211 recognizes the specific display language displayed by the web browser 300 using the display language recognition unit 3013. In this operation example, “Swahili” is recognized.

In step S1202, the CPU 211 recognizes the enterable keys managed by the first OSK management unit 3003 using the first OSK input key recognition unit 3014. In this operation example, the enterable key 6006 recognizes “English” and “Japanese”.

The CPU 211 passes the “Swahili” recognized in step S1201 and the “English” and “Japanese” recognized in step S1202 to the input key determination unit 3016. The input key determination unit 3016 determines whether or not the display language is included in the enterable keys. In the present example, the process proceeds to step S1204 because the display language is not included in the enterable keys.

In step S1204, the CPU 211 uses the second OSK input key recognition unit 3015 to recognize the enterable keys by the second OSK of a corresponding content 706 recognized in step S405. In the present example, “English”, “Japanese”, and “Swahili” are recognized.

In step S1205, the CPU 211 passes the display language “English” and “Japanese”, and “Swahili” recognized in step S1201 and the enterable keys recognized in step S1204 to the input key determination unit 3016. The input key determination unit 3016 determines whether or not the display language is included in the enterable keys. In this operation example, the process proceeds to step S407 because the display language is included in the enterable keys.

For the subsequent processing, the same processing as in the first and second embodiments is performed. Even if the first OSK has priority, the second OSK is provided instead of the first OSK if the second OSK has more enterable keys than the first OSK. The effect of enhancing the usability of character input is achieved.

### Fourth Embodiment

In a case where the use of either the second OSK or the first OSK can not be determined in advance and the second OSK is provided by the web content, an embodiment in which a list of available OSK suggestions is provided to the user is described. Descriptions of the same parts as those of the first embodiment will be omitted and differences will be described.

(Software Configuration of the Image Forming Apparatus)

FIG. 3 illustrates the software configuration diagram of each control program stored in the ROM 212 of the image forming apparatus 101, and each control of the image forming apparatus 101 is realized by executing each of these control programs by the CPU 211. In addition to the control program described in the first embodiment, the web browser 300 includes a launch candidate management unit 3017, a launch candidate display unit 3018, and a launch candidate selection unit 3019.

The launch candidate management unit 3017 registers and provides the passed launch candidates. FIG. 6D illustrates an image of a launch candidate management table. Specifically, the launch candidate management unit 3017 manages the launch target OSK and the launch target application. The launch candidate display unit 3018 controls display of the list of launch candidates acquired from the launch candidate management unit 3017. The launch candidate selection unit 3019 recognizes launch candidates selectable in the list displayed by the launch candidate display unit 3018.

(Registration Processing of the Second OSK)

FIG. 13 illustrates a flowchart showing the second OSK registration processing, in which the web browser 300 of the image forming apparatus 101 in the present embodiment receives a response of the web content 700 from the server 102, recognizes and executes the acquired web content 700. Each step shown in the flowchart of FIG. 13 is executed by the CPU 211 of the image forming apparatus 101 deploying a control program stored in a memory such as the ROM 212 to the RAM 213 and executing the control program.

In step S1301, the CPU 211 registers the second OSK recognized by the corresponding content recognition unit 3005 and its execution application in the launch candidate management unit 3017. In step S1302, the CPU 211 acquires the first OSK and its execution application from the first OSK management unit 3003, and registers the first OSK and its execution application in the launch candidate management unit 3017.

(Launch Processing of the Second OSK)

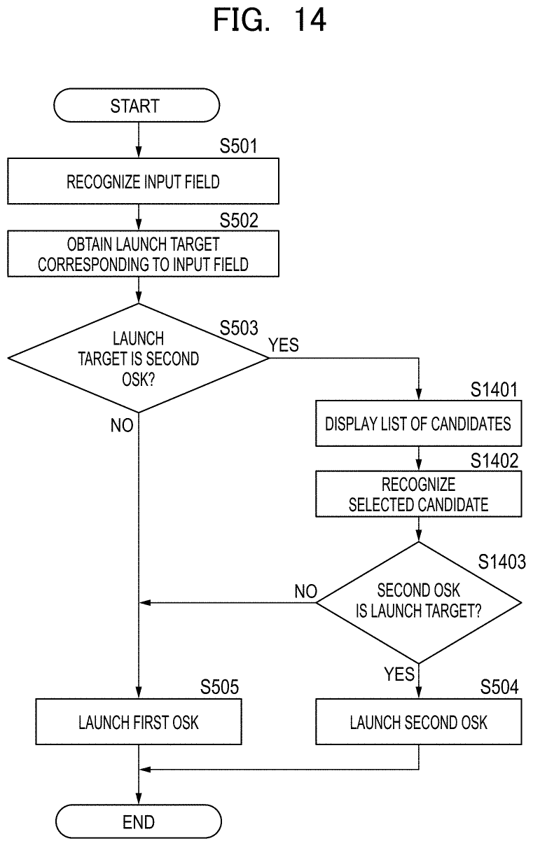

FIG. 14 illustrates a flowchart showing the second OSK launch processing, in which the user touches the input field in the web browser 300 of the image forming apparatus 101 in the present embodiment, the CPU 211 recognizes the touch of the input field of the web browser 300, and executes the launching second OSK. Each step shown in the flowchart of FIG. 14 is executed by the CPU 211 of the image forming apparatus 101 deploying a control program stored in a memory such as the ROM 212 to the RAM 213 and executing the control program.

In step S503, the CPU 211 passes the OSK acquired in step S502 to the launch target determination unit 3009 to determine whether or not the second OSK is a launch target OSK. If the second OSK is a launch target OSK, the process proceeds to step S1401. On the other hand, if the second OSK is not a launch target OSK, the process proceeds to step S505.

In step S1401, the CPU 211 uses the launch candidate display unit 3018 to perform display control so that the launch candidate list managed by the launch candidate management unit 3017 is displayed on the liquid crystal display unit. In step S1402, the CPU 211 recognizes a specific launch candidate selected by the user from the launch candidate list displayed by the launch candidate display unit 3018 using the launch candidate selection unit 3019.

In step S503, the CPU 211 passes the OSK recognized in step S1402 to the launch target determination unit 3009 to determine whether or not the launch target OSK is the second OSK. If the launch target OSK is the second OSK, the process proceeds to step S504. On the other hand, if the launch target OSK is not the second OSK, the process proceeds to step S505.

An example of applying the second OSK registration process and the second OSK launch process will be described using FIGS. 7A, 6D, and 10.

(Example of Registration of the Second OSK)

The web browser 300 receives a response of the web content 700 from the server 102, recognizes the acquired web content 700, and executes the second OSK registration process shown in FIG. 13.

In step S1301, the CPU 211 registers the second OSK recognized by the corresponding content recognition unit 3005 in the launch candidate management unit 3017. The CPU 211 registers the second OSK 6007 as a launch target OSK, and registers the launch application 6008 recognized by the corresponding content recognition unit 3005 as a launch application. In step S1302, the CPU 211 acquires the first OSK from the first OSK management unit 3003 and registers the first OSK in the launch candidate management unit 3017. The first OSK 6009 is registered as the launch target OSK and the launch application 6010 of the acquired first OSK is registered as the launch application.

(Example of Launch of the OSK)

FIG. 14 illustrates the flowchart showing the second OSK launch processing, in which the user touches the input field in the web browser 300 of the image forming apparatus 101 in the present embodiment, the CPU 211 recognizes the touch of the input field of the web browser 300 and executes the launching second OSK.

In step S503, the CPU 211 passes the OSK acquired in step S502 to the launch target determination unit 3009 to determine whether or not the second OSK is the launch target OSK. In the present example, it is determined that the second OSK is the launch target OSK and the process proceeds to step S1401.

In step S1401, the CPU 211 uses the launch candidate display unit 3018 to perform display control so that the launch candidate list managed by the launch candidate management unit 3017 is displayed on the liquid crystal display unit. FIG. 10 is an image of the OSK candidate list screen to be displayed. The user can select either the second OSK 1001 or the first OSK 1002.

According to the present embodiment, if the second OSK is provided by the web content, a list of selectable candidates of the second OSK or the first OSK is provided, and OSK selection according to the user's preference is made possible to enhance the usability of character input.

While the image forming apparatus has been described as an example in the above embodiment, the present invention can be any information processing apparatus as long as a web browser is launched on an information processing apparatus connected to a network and an on-screen keyboard for input is launched. Specifically, the technology can be applied to tablet terminals, PCs, mobile phones, and anything else. It is also naturally applicable to referring to the web content stored in an information processing apparatus without being connected to a network.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-166478, filed Oct. 8, 2021, which is hereby incorporated by reference herein in its entirety.

What is claimed is:

1. An information processing apparatus comprising:
a memory; and
at least one processor in communication with the memory configured to perform:
accepting an operation on an input field included in a web content obtained via a network; and
controlling whether or not a first on-screen keyboard used on the information processing apparatus is displayed if the operation is accepted.

2. The information processing apparatus according to claim 1, wherein the first on-screen keyboard is not displayed if a second on-screen keyboard associated with the input field is included in the web content.

3. The information processing apparatus according to claim 2, wherein the at least one processor is further configured to perform:
setting priority to display either the first on-screen keyboard or the second on-screen keyboard; and
controlling, based on the priority, whether or not the first on-screen keyboard is to be displayed if the operation is accepted.

4. The information processing apparatus according to claim 2, wherein the first on-screen keyboard is displayed if the second on-screen keyboard is not included in the web content.

5. The information processing apparatus according to claim 3, wherein, even if the priority is set to display the first on-screen keyboard, the second on-screen keyboard is displayed in a case where a character associated with the input field cannot be input by using the first on-screen keyboard.

6. The information processing apparatus according to claim 2, wherein the second on-screen keyboard is displayed if language used on the web content is not included in a character included in the first on-screen keyboard.

7. The information processing apparatus according to claim 2, wherein the at least one processor is further configured to perform:
displaying a list of on-screen keyboards including the first on-screen keyboard and the second on-screen keyboard so as to be selectable by a user; and
displaying an on-screen keyboard selected by the user when the user inputs characters in the input field.

8. The information processing apparatus according to claim 1, wherein the information processing apparatus is an image forming apparatus including a printing function.

9. A method for controlling an information processing apparatus comprising:
accepting an operation on an input field included in a web content obtained via a network; and
controlling whether or not a first on-screen keyboard used on the information processing apparatus is displayed if the operation is accepted.

10. A non-transitory computer-readable storage medium storing a program to cause a computer to perform a method for controlling an information processing apparatus, the method comprising:
accepting an operation on an input field included in a web content obtained via a network; and
controlling whether or not a first on-screen keyboard used on the information processing apparatus is displayed if the operation is accepted.
